(19) United States
(12) Patent Application Publication
(10) Pub. No.: US 2023/0374407 A1
(43) Pub. Date: Nov. 23, 2023

(54) MODIFIED PHYSICAL OIL REFINING WITH EMBEDDED ALKALINE TREATMENT

(71) Applicant: Archer Daniels Midland Company, Decatur, IL (US)

(72) Inventors: Lori Wicklund, Argenta, IL (US); Jeremie Groos, Decatur, IL (US)

(21) Appl. No.: 18/247,993

(22) PCT Filed: Oct. 5, 2021
(86) PCT No.: PCT/US2021/053638

§ 371 Date: Apr. 5, 2023

Related U.S. Application Data
(60) Provisional application No. 63/088,160, filed on Oct. 6, 2020.

(51) Int. Cl. C11B 3/00; C11B 3/14; C11B 3/06; C11B 3/04; A23D 9/04; A23L 5/20

(52) U.S. Cl. CPC C11B 3/001; C11B 3/006; C11B 3/14; C11B 3/06; C11B 3/04; A23D 9/04; A23L 5/20

(57) ABSTRACT

A process for producing degummed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25.0 mg/kg is provided. The disclosed process is a quick, cost-effective and easily scalable process for producing refined palm oil of high quality.

### CROSS-REFERENCE TO RELATED APPLICATIONS

This application is a national stage entry of International Application No. PCT/US21/53638, filed Oct. 5, 2021, which itself claims priority to U.S. Provisional Patent Application No. 63/088,160, filed Oct. 6, 2020, the contents of each are incorporated herein by reference.

### FIELD OF THE INVENTION

A process for producing degummed or water-washed, fatty acid-depleted, bleached and deodorized palm oil with no altered solid fat content and containing minimal levels of process contaminants is provided. Also disclosed is a refined palm oil of high quality that may be used in food processing. The refined palm oil has a very low level of contaminants that meets food regulatory most restrictive requirements.

### BACKGROUND

Palm oil is an edible vegetable oil, widely used as cooking oil and as a basis for soap products, derived from the fruit mesocarp of oil palms, such as Elaeis guineensis, Elaeis oleifera and Attalea maripa. Palm oil has high concentrations of palmitic acid and monounsaturated oleic acid and is enriched in tocotrienol, a source of vitamin E.

Crude palm oil refining process can involve fractionation with crystallization and separation to obtain solid palm stearin and liquid olein fractions. These fractions are subject to melting and degumming to remove impurities, followed by filtration and bleaching. Physical refining removes smells and coloration to produce refined, bleached and deodorized palm oil (RBDPO) free of fatty acids, which is used for food applications and to manufacture olechemicals, soaps and washing powders. Physical refining, however, generates significant levels of process contaminants, such as monochloropropanediol (MCPDe), glycidyl fatty acid ester (GE). In addition, where RBDPO is modified by chemical interesterification for specific fat applications, such as for producing margarine or spreads, additional process contaminants, such as dialkylketones (DAK), can form. In particular, RBDPO that is sold in the market contains 3-MCPD levels, which are above the 2.5 mg/kg concentration limit of 3-MCPD, which is going to be enforced in Europe beginning Jan. 1, 2021.

Some potential solutions that in theory are commercially available for introducing RBDPO containing less than 2.5 mg/kg 3-MCPD into the European market include selecting crude palm oil sources that have a potential to generate lower levels of 3-MCPD; water-washing and pre-treating crude palm oil at origination prior to shipment to Europe; chemical refining of crude palm oil; short path distillation following physical refining; and purchasing refined RBDPO. These approaches, however, are not economically viable, as they are very expensive and may not meet the soon to be imposed European regulations concerning 3-MCPD concentration limit in marketed palm oil. For example, full chemical refining requires an expensive centrifuge supported caustic neutralization process with soap splitting and extended wastewater treatment process. Similarly, processes that involve increased deodorizing capacity and modified temperature profile require high-cost centrifuge-supported degumming and deodorizing columns. Short path distillation is also plagued by high cost production and it requires expensive oxidation stabilizing additives to meet RBDPO specifications.

Alternative economically viable solutions that generate low levels of 3-MPD while maintaining high quality standards, including place of origin, planting, harvesting, and storage time and conditions, without causing detrimental effects on current RBD palm oil properties, are therefore urgently needed.

### SUMMARY

The present application presents a solution to the aforementioned challenges by providing quick, cost-effective and easily scalable processes for producing refined palm oil of high quality. The disclosed processes are easy to implement into existing physical refining plants, are adaptable to different process conditions, requires low capital investment, and provide refined palm oil with a very low level of contaminants that meet the most restrictive requirements. The resulting refined palm oil may be used for food processing, soap and power washer production, and any other suitable application.

Thus, in some embodiments, provided herein is a method for inhibiting or reducing 3-monochloropropanediol (3-MCPD), 2-monochloropropanediol (2-MCPD), glycidyl ester (GE) and dialkyl ketone (DAK) in palm oil. The disclosed method comprises in non-sequential order (i) degumming or washing palm oil to produce degummed or water-washed palm oil; (ii) contacting degummed or water-washed palm oil with a base, soap or a mixture thereof, and removing free fatty acids by fatty acid distillation to produce fatty acid-depleted palm oil; (iii) bleaching the fatty acid-depleted palm oil; and (iv) deodorizing the bleached palm oil to obtain a degummed or water-washed, fatty acid-depleted, bleached and deodorized palm oil, thereby inhibiting or reducing 3-monochloropropanediol (3-MCPD), 2-monochloropropanediol (2-MCPD), glycidyl ester (GE) and dialkyl ketone (DAK) in palm oil.

In some embodiments, degumming comprises dry degumming. In other embodiments, degumming comprises acid degumming. In yet other embodiments, degumming comprises water washing. In some embodiments, acid degumming comprises heating palm oil; adding acid and water to the palm oil; and removing water gum phase by gravity or density.

In some embodiments, the base, soap or a mixture thereof is added to the degummed or water-washed palm oil prior to fatty acid distillation. In other embodiments, the base, soap or a mixture thereof is added to the degummed or water-washed palm oil after fatty acid distillation. In some embodiments, fatty acid distillation comprises exposing the palm oil to a temperature higher than 240° C. at a reduced pressure of less than 10 mbar with continuous addition of steam.

In some embodiments, contacting degummed or water-washed palm oil with a base, soap or a mixture thereof comprises cooling degummed, water-washed or fatty acid-depleted palm oil to a temperature higher than 180° C.; adding the base, soap or a mixture thereof in an amount greater than 50 mg/kg; and stirring for a time period from 1 minute to 4 hours to obtain a caustic-palm oil mixture.

Suitable bases include, but are not limited to, hydroxide basis, such as sodium methoxide, sodium hydroxide, potassium hydroxide, or other alkaline reacting molecules, such as, metal oxides, Lewis basis, sodium carbonate, sodium bicarbonate, potassium carbonate, potassium bicarbonate, sodium salts of fatty acids with carbon chain length between C4 and C24, potassium salts of fatty acids with carbon chain length between C4 and C24, calcium salts of fatty acids, or any mixture thereof.

In some embodiments, bleaching comprises cooling the caustic-palm oil mixture to a temperature below 120° C.; adding acid-activated bleaching clay and stirring under vacuum; and filtering.

In some embodiments, deodorizing bleached palm oil comprises heating bleached palm oil under vacuum and continuous injection of steam.

The resulting degummed or water-washed, fatty acid-depleted, bleached and deodorized palm oil produced by the disclosed method contains 3-MCPD and 2-MCPD in an amount of less than 2.5 mg/kg; GE in an amount of less than 1.0 mg/kg; and DAK in an amount of less than 25.0 mg/kg.

Moreover, inhibition or reduction of 3-MCPD and 2-MCPD, GE and DAK by the disclosed method does not alter solid fat content in the degummed or water-washed, fatty acid-depleted, bleached and deodorized palm oil.

The disclosed method comprises only one bleaching step, which is between fatty acid distillation and deodorization.

In some embodiments, the palm oil processed by the disclosed method is crude palm oil. In other embodiments, the palm oil processed by the disclosed method is refined, bleached and deodorized palm oil or intermediate, fractionated or modified products thereof. In yet other embodiments, the palm oil processed by the disclosed method is a mixture of crude palm oil, refined, bleached and deodorized palm oil, and intermediate, fractionated or modified products of refined, bleached and deodorized palm oil.

In some embodiments, the disclosed method comprises mass-producing degummed or water-washed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25.0 mg/kg.

Additionally provided herein is a degummed or water-washed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25 mg/kg.

In some embodiments, the disclosed degummed or water-washed, fatty acid-depleted, bleached and deodorized palm oil is produced by a method that comprises in non-sequential order (i) degumming or washing palm oil to produce degummed or water-washed palm oil; (ii) contacting degummed or water-washed palm oil with a base, soap or mixture thereof and removing free fatty acids by fatty acid distillation to produce fatty acid-depleted palm oil; (iii) bleaching the fatty acid-depleted palm oil; and (iv) deodorizing bleached palm oil to obtain a degummed or water-washed, fatty acid-depleted, bleached and deodorized palm oil.

In some embodiments, degumming comprises dry degumming. In other embodiments, degumming comprises acid degumming. In yet other embodiments, degumming comprises water washing. In some embodiments, acid degumming comprises heating palm oil; adding acid and water to the palm oil; and removing water gum phase by gravity or density.

In some embodiments, the base, soap or mixture thereof is added to the degummed or water-washed palm oil prior to fatty acid distillation. In other embodiments, the base, soap or mixture thereof is added to the degummed or water-washed palm oil after fatty acid distillation. In some embodiments, fatty acid distillation comprises exposing the palm oil to a temperature higher than 240° C. at a reduced pressure of less than 10 mbar with continuous addition of steam.

In some embodiments, contacting degummed or water-washed palm oil with a base, soap or mixture thereof comprises cooling degummed, water-washed or fatty acid-depleted palm oil to a temperature higher than 180° C.; adding the base, soap or mixture thereof in an amount higher than 50 mg/kg; and stirring for a time period from 1 minute to 4 hours to obtain a caustic-palm oil mixture.

Suitable bases include, but are not limited to, sodium methoxide, sodium hydroxide, potassium hydroxide, a metal oxide, a Lewis base, sodium carbonate, sodium bicarbonate, potassium carbonate, potassium bicarbonate, sodium salts of fatty acids with carbon chain length between C4 and C24, potassium salts of fatty acids with carbon chain length between C4 and C24, calcium salts of fatty acids, and any mixture thereof.

In some embodiments, bleaching comprises cooling the caustic-palm oil mixture to a temperature below 120° C.; adding acid-activated bleaching clay and stirring under vacuum; and filtering.

In some embodiments, deodorizing bleached palm oil comprises heating bleached palm oil under vacuum and continuous injection of steam.

In some embodiments, the source palm oil is crude palm oil. In other embodiments, the source palm oil is refined, bleached and deodorized palm oil or intermediate, fractionated or modified products thereof. In yet other embodiments, the source palm oil is a mixture of crude palm oil, refined, bleached and deodorized palm oil, and intermediate, fractionated or modified products of refined, bleached and deodorized palm oil.

In some embodiments, the degummed or water-washed, fatty acid-depleted, bleached and deodorized palm oil provided herein is mass-produced. The disclosed degummed or water-washed, fatty acid-depleted, bleached and deodorized palm oil has no altered solid fat content and contains 3-MCPD and 2-MCPD in an amount of less than 2.5 mg/kg; GE in an amount of less than 1.0 mg/kg; and DAK in an amount of less than 25.0 mg/kg.

The foregoing and other features of the disclosure will become more apparent from the following detailed description of several embodiments, which proceeds with reference to the accompanying figures.

### BRIEF DESCRIPTION OF THE DRAWINGS

FIG. 1 shows step comparisons of different palm oil refinement processes. STD: standard physical refining process of refined palm oil with low glycidyl ester (GE) content; EAT: embedded alkaline treatment; PEAT: pre-treated embedded alkaline treatment; FEAT: fatty acid-depleted embedded alkaline treatment; PFEAT: pre-treated fatty acid-depleted embedded alkaline treatment; Chemical Ref: chemical refining.

FIG. 2 shows a palm oil refining process scheme as provided herein. Dry degumming as in the EAT process, water washing, or wet degumming, which is performed in the presence of acid (dosage 1) and water (dosage 2) as in the PEAT process, are followed by addition of caustic (dosage 3). Acids, water and gums are then separated by density or gravity (separator 1). In the alternative, caustic (dosage 4) is added after free fatty acid stripping, as in the PFEAT process. Free fatty acid stripping is performed in a stripper (stripper 1) by distilling the oil at 270-290° C. (heater 1) at a reduced pressure of about 1 mbar (vacuum) and with continuous addition of 0.5-1% by weight of steam (stripping steam). The distillate containing the palm oil volatile fraction, including fatty acids, residual glycerides, and water from the steam, is condensed in a cooler (condenser 1). Caustic may be added immediately prior to (dosage 5) and after (dosage 6) free fatty acid stripping, or when cooling down the oil temperature with a spiral cooler (heat exchanger 1) or economizer (heat exchanger 2) to eliminate free fatty acids (dosage 7). Following free fatty acid removal, the fatty acid-depleted oil is bleached by adding acid-activated bleaching clay with stirring for 5 minutes, reducing pressure to about 15 mbar, and stirring for an additional 30 minutes. The fatty acid-depleted palm oil thus obtained is filtered (filter 1), and then deodorized (deodorizer 1) at 180-220° C. and at reduced pressure of about 1-3 mbar with continuous 1% of steam injection.

### DETAILED DESCRIPTION

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise. For example, the phrase “A or B” refers to A, B, or a combination of both A and B. Furthermore, the various elements, features and steps discussed herein, as well as other known equivalents for each such element, feature or step, can be mixed and matched by one of ordinary skill in this art to perform methods in accordance with principles described herein.

Unless explained otherwise, all technical and scientific terms used herein have the same meaning as commonly understood to one of ordinary skill in the art to which this disclosure belongs. The materials, methods, and examples are illustrative only and not intended to be limiting.

In some examples, the numbers expressing quantities of ingredients, properties such as molecular weight, reaction conditions, and so forth, used to describe and claim certain embodiments are to be understood as being modified in some instances by the term “about” or “approximately.” For example, “about” or “approximately” can indicate +/−20% variation of the value it describes. Accordingly, in some embodiments, the numerical parameters set forth herein are approximations that can vary depending upon the desired properties for a particular embodiment. The recitation of ranges of values herein is merely intended to serve as a shorthand method of referring individually to each separate value falling within the range. To facilitate review of the various embodiments of this disclosure, the following explanations of specific terms are provided:

Analog: A compound having a structure similar to another, but differing from it, for example, in one or more atoms, functional groups, or substructure.

Bleaching: A step in the refining process of crude oils and fats following degumming by treatment with phosphoric or citric acid, and removing trace metal complexes such as iron and copper, carotenoids, phosphatides and oxidative products, which impacts adversely the physical appearance and quality of the oil. The bleached oil is then filtered in filter press.

Chemical Refining: A process removing free fatty acids from crude oil, which involves fatty acid neutralization with caustic soda and removal of sodium soap. The resulting oil is then bleached and deodorized.

Contacting: Placing a substance in direct physical association with a material in solid, liquid, or gas form.

Control: A reference standard of a known value or range of values.

Deodorization: A steam distillation process carried out at low pressures and elevated temperatures (180-220° C.) and removing palm oil volatile components, such as aldehydes and ketones, which cause smell in refined oil, free fatty acids and oxidation products.

Dialkyl Ketones (DAKs): Contaminants found in the unsaponifiable fraction of vegetable oils that are formed as byproducts during inter-esterification of fats. Inter-esterification of fats is a common industrial practice to redistribute fatty acids in triglycerides using a chemical catalyst or an enzyme.

Glycidol fatty acid esters (GEs): GEs are main contaminants in almost all refined edible oils, and are formed during the deodorization step in the refining process.

Hybrid Material: A composite consisting of two or more components that are combined into a matrix at nanometer or molecular level. In some cases, one component is inorganic, and one component is organic.

3-Monochloropropanediol (3-MCPD): A heat-induced foodborne processing contaminant occurring frequently in refined edible oils and having possible adverse health effects, including nephrotoxicity. 3-MCPD is produced as a byproduct in foods treated at high temperatures with hydrochloric acid to speed up protein hydrolysis protein hydrolysis, when the chloride reacts with the glycerol backbone of lipids, and is also present in foods that have been in contact with materials containing epichlorohydrin-based wet-strength resins, which are used in the production of tea bags and sausage.

2-Monochloropropanediol (2-MCPD): A heat-induced foodborne processing contaminant occurring frequently in refined edible oils and having possible adverse health effects. 2-MCPD is produced as a byproduct in foods treated at high temperatures with hydrochloric acid to speed up protein hydrolysis protein hydrolysis, when the chloride reacts with the glycerol backbone of lipids, and is also present in foods that have been in contact with materials containing epichlorohydrin-based wet-strength resins, which are used in the production of tea bags and sausage.

Physical Refining: A process removing gums from oil by degumming, which involves free fatty acid removal by steam deodorization.

Refined Palm Oil: A palm oil from which undesirable impurities such as phospholipids, free fatty acids, carotenoids, metal impurities, and water soluble impurities, such as glycerol, phenols and sugars, have been removed by bleaching, deodorization and fractionation.

### Process for Producing Pre-Treated Fatty Acid-Depleted Refined Palm Oil with Law Contaminant Level

Refined palm oil finds use in a wide array of applications, including food processing, cosmetics, animal feed, pharmaceuticals, biofuel and energy, and industry. Traditional palm oil refining processes have significant drawbacks, as they may require expensive equipment and can produce refined palm oil with dangerously high levels of contaminants.

The classical double physical refining process involves the following steps: (i) bleaching and filtering palm oil; (ii) deodorizing the bleached palm oil; (iii) bleaching and filtering the oil; and (iv) deodorizing the oil.

In some embodiments, the first bleaching step in the classical double physical refining process comprises heating the oil to 85° C.; adding acid, stirring and adding natural clay under vacuum. In some embodiments, each deodorization step is performed at elevated temperatures under reduced pressure and continuous steam injection, followed by cooling. In some embodiments, the second bleaching step comprises cooling the oil to a temperature below 120° C., preferably between 85° C. and 120° C., and adding acidic clay under vacuum.

Thus, the classical double physical refining process is a time consuming process, as it requires repetitive bleaching and deodorizing steps. In addition, the refined, bleached and deodorized palm oil produced by the classical double physical refining process has unacceptable high levels of contaminants.

The inventors have explored several modification processes as alternatives to address these drawbacks.

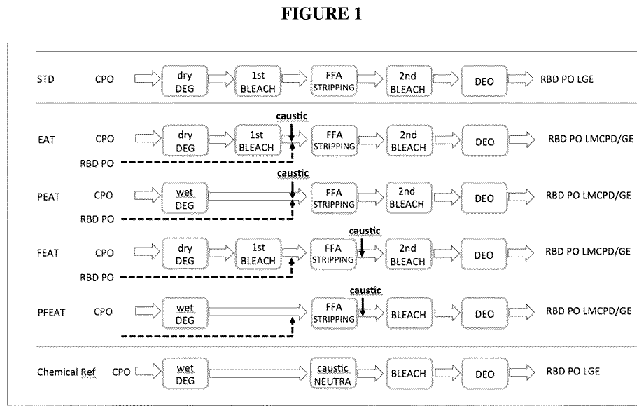

In some embodiments, a first modification is a process described as embedded alkaline treatment (EAT), which includes dry degumming (FIG. 1). In particular, the EAT process involves the following steps: (i) degumming palm oil and removing the gum phase by gravity or density; (ii) bleaching; (iii) adding a base, soap or mixture thereof; (iv) deodorizing and cooling the oil; (iv) bleaching and filtering the deodorized oil; and (v) deodorizing the oil.

In some embodiments, dry-degumming palm oil in the EAT process comprises heating the oil to 85° C. In some embodiments, the acid comprises a 50% citric acid solution, and the citric acid solution is added in an amount from 200 ppm to 1,000 ppm.

In some embodiment, the base is one or more of sodium methoxide, sodium hydroxide, potassium hydroxide, a metal oxide, a Lewis base, sodium carbonate, sodium bicarbonate, potassium carbonate, potassium bicarbonate, a sodium salt of a fatty acid having carbon chain length between C4 and C24, a potassium salt of a fatty acid having carbon chain length between C4 and C24, or a calcium salt of a fatty acid. In some embodiments, the base is added in an amount from 50 to 1200 mg/kg.

In some embodiment, each deodorization step is performed at elevated temperatures and at reduced pressure under continuous steam injection. In some embodiments, bleaching the deodorized oil comprises heating the oil to a temperature between 85° C. and 120° C., and adding acidic clay under vacuum.

The EAT process results in a significant reduction in 3-MCPD 2-MCPD and glycidol ester (GE). However, the EAT process does not reduce diakylketones and it significantly alters solid fat content.

In some embodiments, a second modification is a process described as pre-treated embedded alkaline-treatment (PEAT), which substitutes dry degumming and the first bleaching step in the EAT process with wet degumming (FIG. 1). Thus, the PEAT process involves the following steps: (i) acid-degumming or water washing palm oil, mixing, and removing water gum phase by gravity or density; (ii) adding a base, soap, or mixture thereof to the degummed palm oil, and removing free fatty acid by fatty acid distillation; (iii) bleaching and filtering the oil; and (iv) deodorizing the oil.

In some embodiments, acid degumming in the PEAT process comprises heating the palm oil, adding acid and water, and removing water gum phase by gravity or density. In some embodiments, the oil is heated to 85° C. during the degumming process. In some embodiments, the acid comprises a phosphoric or citric acid solution (50% w/w), and the phosphoric or citric acid solution is added in an amount from 200 to 1000 mg/kg. In some embodiments, the water is demineralized water.

In some embodiment, the base, soap or mixture thereof is one or more of sodium methoxide, sodium hydroxide, potassium hydroxide, a metal oxide, a Lewis base, sodium carbonate, sodium bicarbonate, potassium carbonate, potassium bicarbonate, a sodium salt of a fatty acid having carbon chain length between C4 and C24, a potassium salt of a fatty acid having carbon chain length between C4 and C24, or a calcium salt of a fatty acid. In some embodiments, the base, soap or mixture thereof is added in an amount from 500 to 2,500 mg/kg.

In some embodiments, fatty acid distillation comprises heating the oil to a temperature higher than 240° C. under reduced pressure and continuous steam injection.

In some embodiments, bleaching comprises cooling the oil to a temperature below 120° C., preferably between 85° C. and 120° C., and adding acidic clay under vacuum.

In some embodiment, the oil is deodorized at elevated temperatures and at reduced pressure under continuous steam injection.

The pre-treated embedded alkaline treatment (PEAT) process presents advantages over the EAT process, as it significantly reduces 3-MCPD and 2-MCPD and somewhat decreases diakylketones in palm oil, without causing major alterations in solid fat content. Nevertheless, the PEAT process leaves a relatively high level of diakylketones in the final refined palm oil product.

In some embodiments, a third modification is a process described as fatty acid-depleted, embedded alkaline-treatment (FEAT), which includes dry degumming as in the EAT process, and fatty acid distillation between two bleaching steps. Thus, the FEAT process involves the following steps: (i) dry-degumming palm oil; (ii) bleaching and filtering degummed palm oil; (iii) removing free fatty acid by fatty acid distillation; (iv) cooling the oil to room temperature and adding a base, soap, or mixture thereof to the oil; (v) bleaching and filtering the oil; and (vi) deodorizing the oil.

In some embodiments, dry-degumming palm oil in the FEAT process comprises heating the oil to 85° C. In some embodiments, the acid comprises a 50% phosphoric acid solution, and the phosphoric acid solution is added in an amount from 200 ppm to 1,000 ppm.

In some embodiments, each bleaching step comprises cooling the oil to a temperature below 120° C., preferably between 85° C. and 120° C., and adding acidic clay under vacuum.

In some embodiments, fatty acid distillation comprises heating the oil to a temperature higher than 240° C. under reduced pressure and continuous steam injection.

In some embodiment, the base, soap or mixture thereof is one or more of sodium methoxide, sodium hydroxide, potassium hydroxide, a metal oxide, a Lewis base, sodium carbonate, sodium bicarbonate, potassium carbonate, potassium bicarbonate, a sodium salt of a fatty acid having carbon chain length between C4 and C24, a potassium salt of a fatty acid having carbon chain length between C4 and C24, or a calcium salt of a fatty acid. In some embodiments, the base, soap or mixture thereof is added in an amount from 500 to 2,500 mg/kg.

In some embodiment, the oil is deodorized at elevated temperatures and at reduced pressure under continuous steam injection.

The fatty acid-depleted, embedded alkaline-treatment (FEAT) process presents advantages over the EAT process, as it significantly reduces 3-MCPD, 2-MCPD, glycidol ester (GE) and diakylketone in refined palm oil, without causing any significant alterations in solid fat content.

In some embodiments, to further decrease contaminant levels in refined palm oil, a fourth modification is a process described as pre-treated, fatty acid-depleted, embedded alkaline-treatment (PFEAT). The PFEAT process substitutes dry degumming and the first bleaching step in the EAT process with wet degumming, inserts a caustic step after fatty acid distillation, and comprises only one bleaching step between fatty acid distillation and deodorization (FIG. 1). Thus, the PFEAT process involves the following steps: (i) acid-degumming or water-washing palm oil and removing water gum phase by gravity or density; (ii) removing free fatty acids by fatty acid distillation; (iii) cooling the oil and adding a base, soap, or mixture thereof; (iv) bleaching and filtering the oil; and (v) deodorizing the oil.

In some embodiments, acid degumming in the PFEAT process comprises heating the palm oil, adding acid and water, and removing water gum phase by gravity or density. In some embodiments, the oil is heated to 85° C. during the degumming process. In some embodiments, the acid comprises a phosphoric or citric acid solution (50% w/w), and the phosphoric or citric acid solution is added in an amount from 200 to 1000 mg/kg. In some embodiments, the water is demineralized water, and the demineralized water is added in an amount from 0.5% to 10% by weight.

In some embodiments, fatty acid distillation comprises heating the oil to a temperature higher than 240° C. under reduced pressure and continuous steam injection, and then cooling the oil. In some embodiments, the oil is cooled to a temperature higher than 180° C.

In some embodiment, the base, soap or mixture thereof is one or more of sodium methoxide, sodium hydroxide, potassium hydroxide, a metal oxide, a Lewis base, sodium carbonate, sodium bicarbonate, potassium carbonate, potassium bicarbonate, a sodium salt of a fatty acid having carbon chain length between C4 and C24, a potassium salt of a fatty acid having carbon chain length between C4 and C24, or a calcium salt of a fatty acid. In some embodiments, the base, soap or mixture thereof is added in an amount from 500 to 2,500 mg/kg.

In some embodiments, the bleaching step comprises cooling the oil to a temperature below 120° C., preferably between 85° C. and 120° C., and adding acidic clay under vacuum.

In some embodiment, the oil is deodorized at elevated temperatures and at reduced pressure under continuous steam injection.

The pre-treated fatty acid-depleted, embedded alkaline-treatment (PFEAT) process presents advantages over the EAT process, as it significantly reduces 3-MCPD, 2-MCPD, glycidol ester (GE) and diakylketone in refined palm oil, without causing any significant alterations in solid fat content. The PFEAT process is especially suitable for mass production of refined palm oil with low contaminant levels.

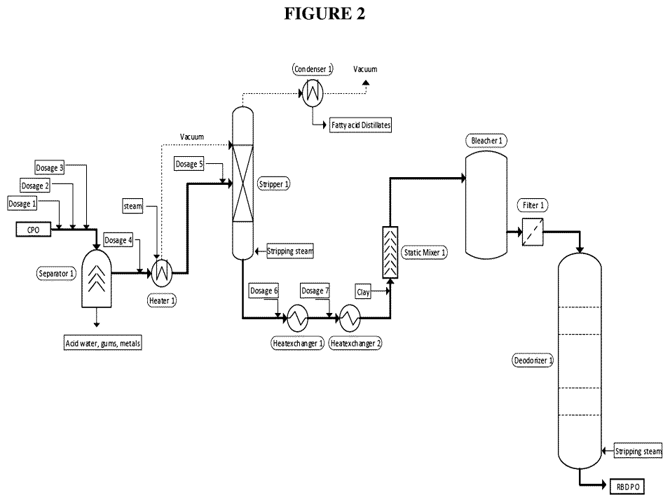

As shown in FIG. 2, the palm oil refinement process scheme provided herein includes dry degumming as in the EAT process, water washing, or wet degumming, which is performed in the presence of acid (dosage 1) and water (dosage 2) as in the PEAT and in the PFEAT processes. Degumming may be followed by addition of caustic (dosage 3), as in the PEAT process. Acids, water and gums are then separated by centrifugation (separator 1). In the alternative, caustic (dosage 4) is added after free fatty acid distillation, as in the PFEAT process. Free fatty acid distillation is performed in a stripper (stripper 1) at elevated temperatures (heater 1) under reduced pressure (vacuum) and continuous addition of steam (stripping steam). The distillate containing the palm oil volatile fraction, including fatty acids, residual glycerides, and water from the steam, is condensed in a cooler (condenser 1). A base, soap or mixture thereof may be added immediately prior to (dosage 5) and after (dosage 6) free fatty acid distillation, or when cooling down the oil temperature with a spiral cooler (heat exchanger 1) or economizer (heat exchanger 2) to eliminate free fatty acids (dosage 7). Following free fatty acid removal, the fatty acid-depleted oil is bleached with acidic clay under reduced pressure, filtered (filter 1), and then deodorized (deodorizer 1) at elevated temperatures under reduced pressure and continuous steam injection.

Thus, the disclosed process may involve caustic addition at different stages to produce highly refined palm oil with low contaminant level and unaltered fatty acid composition. In addition, the highly refined palm oil produced as disclosed herein exhibits fast retention times. In some embodiment, retention time at 285° C. is about 1 minute.

The disclosed highly refined palm oil contains 3-MCPD and 2-MCPD in an amount of less than 2.5 mg/kg, preferably less than 2.0 mg/kg, and more preferably less than 1 mg/kg; GE in an amount of less than 1.0 mg/kg, and preferably less than 0.2 mg/kg; and DAK in an amount of less than 25.0 mg/kg. Therefore, the highly refined palm oil produced by the methods provided herein meets the most restrictive health guideline requirements, and it can be used for food processing, soap and power washer production, and any other suitable application.

The following examples illustrate methods for inhibiting or reducing monochloropropanediols, esters thereof and/or dialkylketones from crude and refined palm oils and fats of different quality and processing grades. These examples additionally illustrate how to obtain highly refined palm oil compositions containing low levels of monochloropropanediols, esters thereof, and dialkylketones, according to the methods presented herein.

### EXAMPLES

### Example 1: Reference Classic Physical Refining, Double Refining

Crude palm oil samples containing more than 1% of free fatty acids (FFAs), 10 mg/kg phosphorus (P) and more than 2 mg/kg chlorine were dry-degummed by heating to 85° C. 200 mg/kg 50% phosphoric acid solution was added and mixed for 15 minutes, and 0.5% natural bleaching clay was then added and mixed for additional 5 minutes at 85° C. at reduced pressure (15-800 mbar) and filtrated.

The degummed and bleached palm oil thus obtained was subject to fatty acid distillation at a temperature in a range between 270° C. and 290° C. at reduced pressure of about 1 mbar and with continuous addition of 0.5-1% by weight of steam. Refined palm oil retention time at 285° C. was between about 1 minute and about 30 minutes, before the temperature was cooled down to less than 100° C.

The refined palm oil was then mixed with 2% by weight of acid-activated bleaching clay for 5 minutes at 15 mbar pressure and filtrated. The palm oil was then subject to deodoration at 180-220° C. at reduced pressure (1-3 mbar), and injected continuously with about 1% of steam over a retention time of 30 minutes.

The palm oil samples thus obtained were cooled to room temperature and analyzed for monochloropropanediol (MCPDe) content, glycidyl fatty acid ester (GE) content, solid fat (SF) content and dialkylketone (DAK) content. The results, which are shown in Table 2, indicate that classic refining of crude palm oil leaves a high level of contaminants in the refined product.

### Example 2: Acid Degumming-Treated Crude Palm Oil (PTX) Physical Refining, Double Refining

Crude palm oil samples containing more than 1% of free fatty acids (5.2% average), 10 mg/kg phosphorus (P) and more than 2 mg/kg (from about 1.8 to about 12 mg/kg) chloride were acid-degummed by heating to 85° C. About 200 to about 1000 mg/kg 50% phosphoric or citric acid solution, about 200 to about 1,000 mg/kg caustic, and from about 0.5% to about 10% by weight of demineralized water were then added and mixed for 15 minutes, followed by acid water gum phase removal by centrifugation.

Table 1 below shows the effect of acid degumming on phosphorous, metal and chloride reduction in acid degumming-treated crude palm oil (PTX) as compared to untreated crude palm oil (CPO).

TABLE 1

| | FFA | P | Fe | Mg | Ca |
|---|---|---|---|---|---|
| Sample | [%] | [mg/kg] | [mg/kg] | [mg/kg] | [mg/kg] |
| CPO | 5.9 | 25.8 | 7.9 | 6.4 | 25.1 |
| PTX | 5.6 | 8.4 | 2.2 | <LOQ* | 1.5 |

*LOQ = limit of quantification
FFA = free fatty acids

The results in Table 1 show that acid degumming treatment significantly reduced phosphorous, iron, magnesium and calcium content in palm oil.

Following heavy phase separation, the acid degummed palm oil was subject to fatty acid distillation at a temperature in a range between 270° C. and 290° C. at reduced pressure of about 1 mbar and with continuous addition of 0.5-1% by weight of steam. Fatty acid-depleted palm oil retention time at 285° C. was about 1 minute.

Acid-activated clay in an amount from about 0.5 to about 4% by weight was then added and stirred for 5 minutes. Pressure was then reduced to about 15 mbar, and the mixture was stirred for an additional 30 minutes and filtered.

The palm oil was then subject to deodoration at 180-220° C. at reduced pressure (1-3 mbar), and injected continuously with about 1% of steam over a retention time of 30 minutes.

The palm oil samples thus obtained were cooled to room temperature and analyzed for monochloropropanediol (MCPDe) content and free fatty acid content. The results are shown in Table 2.

Table 2 shows the content of process contaminants in acid-degummed refined palm oil (RBD PO) as compared to reference classic-refined palm oil (RBD PO) from Example 1. The results in Table 2 show that PTX treatment reduced 3-MCPD content. However, the reduction in 3-MCPD did not reach the desired level of <1.5 mg/kg.

TABLE 2

| | FFA | 3-MCPD | 2-MCPD |
|---|---|---|---|
| Sample | [%] | [mg/kg] | [mg/kg] |
| Reference RBD PO | 6.3 | 3.3 | 1.5 |
| PTX-treated RBD PO | 5.8 | 1.9 | 1.4 |

RBD PO = refined bleached deodorized palm oil

### Example 3: Embedded Alkaline-Treated Crude Palm Oil (PTX) Physical Refining, Double Refining

Crude palm oil samples containing more than 1% of free fatty acids (5.2% average) were dry-degummed and bleached by heating the samples up to 85° C., followed by addition of about 200 mg/kg 50% by weight of phosphoric or citric acid solution and mixing for 15 minutes at 85° C. 0.5% by weight of natural clay was then added, and the mixture was stirred for 5 minutes. Pressure was then reduced to 15 mbar, and the mixture was stirred for 30 minutes and filtered.

About 500-2,500 mg/kg of soap or an equivalent amount of caustic solution (70-360 mg/kg, pure base) were added to the degummed and bleached palm oil samples thus obtained. The samples were heated to 285° C. for fatty acid stripping at reduced pressure of about 1-3 mbar, with about 1% steam injection and a retention time of 1 minute.

The degummed, bleached and fatty acid-depleted palm oil samples were cooled down to 85° C., and about 1-4% acid-activated bleach clay was added. The mixture was stirred for 5 minutes at a reduced pressure of about 15 mbar, and filtered to obtain degummed, bleached, fatty acid-depleted palm oil samples with low MCPD and glycidyl ester content. The resulting products were deodorized at 180-220° C., cooled to room temperature, and analyzed for monochloropropanediol ester (MCPDe) content, glycidyl fatty acid ester (GE) content, solid fat (SF) content and dialkylketone (DAK) content. The results, which are shown in Table 3 and Table 4 below, indicate that the embedded alkaline treatment (EAT) process significantly reduces 3-MCPD content, but it leaves a high level of diakylketones and it significantly alters solid fat content.

TABLE 3
Process contaminant presence in EAT-treated refined
palm oil (RBD PO) as compared to reference RBD
PO obtained from classic physical refining

| | 3-MCPD | 2-MCPD | GE | DAK |
|---|---|---|---|---|
| Sample | [mg/kg] | [mg/kg] | [mg/kg] | [mg/kg] |
| Reference RBD PO | 3.3 | 1.5 | 0.3 | <2.3 |
| EAT-Treated RBD PO | 0.6 | N/A | 0.4 | <175.0 |

TABLE 4
Solid fat content in EAT-treated refined palm oil (RBD PO) as compared
to reference RBD PO obtained from classic physical refining

| | N20 | N30 | N40 |
|---|---|---|---|
| Sample | [%] | [%] | [%] |
| Reference RBD PO | 20.8 | 9.1 | 2.3 |
| EAT-Treated RBD PO | 28.5 | 11.0 | 3.0 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

### Example 4: Pre-Treated Embedded Alkaline-Treated Crude Palm Oil (PEAT) Physical Refining, Double Refining

Crude palm oil samples containing more than 1% of free fatty acids, 10 mg/kg phosphorus (P) and more than 2 mg/kg chloride were acid-degummed by heating to 85° C. About 200 to about 1000 mg/kg 50% by weight of phosphoric or citric acid solution, and from about 0.5% to about 10% by weight of demineralized water were then added and mixed for 15 minutes, followed by acid water gum phase removal by centrifugation.

Following heavy phase separation, about 500-2,500 mg/kg of caustic solution (70-360 mg/kg, pure base) were added to the degummed oil samples, and the samples were subject to fatty acid distillation at a temperature in a range between 270° C. and 290° C. at reduced pressure of about 1 mbar and with continuous addition of 0.5-1% by weight of steam. Retention time at 285° C. was about 1 minute.

Acid-activated clay in an amount from about 0.5 to about 4% by weight was then added and stirred for 5 minutes. Pressure was then reduced to about 15 mbar, and the mixture was stirred for an additional 30 minutes and filtered.

The palm oil samples were then subject to deodoration at 180-220° C. at reduced pressure (1-3 mbar), and injected continuously with about 1% of steam over a retention time of 30 minutes. The samples were cooled to room temperature and analyzed for monochloropropanediol (MCPDe) content, glycidyl fatty acid ester (GE) content, solid fat (SF) content and dialkylketone (DAK) content. The results, which are shown in Table 5 and Table 6 below, indicate that the pre-treated embedded alkaline treatment (PEAT) process significantly reduces 3-MCPD content and somewhat decreases diakylketone content in palm oil, without causing major alterations in solid fat content.

TABLE 5
Process contaminant presence in PEAT-treated refined
palm oil (RBD PO) as compared to reference RBD
PO obtained from classic physical refining.

| | 3-MCPD | 2-MCPD | GE | DAK |
|---|---|---|---|---|
| Sample | [mg/kg] | [mg/kg] | [mg/kg] | [mg/kg] |
| Reference RBD PO | 3.3 | 1.5 | 0.3 | <2.3 |
| PEAT-Treated RBD PO | 1.2 | N/A | 0.5 | <75 |

TABLE 6
Solid fat content in PEAT-treated refined palm
oil (RBD PO) as compared to reference RBD PO
obtained from classic physical refining.

| | N20 | N30 | N40 |
|---|---|---|---|
| Sample | [%] | [%] | [%] |
| Reference RBD PO | 20.8 | 9.1 | 2.3 |
| PEAT-Treated RBD PO | 25.1 | 10.3 | 2.0 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

### Example 5: Fatty Acid-Depleted, Embedded Alkaline-Treated Crude Palm Oil (FEAT) Physical Refining, Double Refining

Crude palm oil samples containing more than 1% of free fatty acids and 10 mg/kg phosphorus (P) were dry-degummed by heating to 85° C. About 200 mg/kg 50% by weight of phosphoric solution was added and mixed for 15 minutes at 250 rpm, and 0.5% by weight of natural bleaching clay was added to the mixture and stirred for additional 5 minutes at 85° C. at a reduced pressure of about 15-800 mbar before filtering.

The degummed and bleached palm oil samples thus obtained were subject to fatty acid distillation at 270-290° C. at a reduced pressure of about 1 mbar and with continuous addition of 0.5-1% by weight of steam. Retention time at 285° C. was about 1 minute. The fatty acid-depleted palm oil (FAD PO) samples were cooled down to room temperature and about 50 to about 200 mg/kg caustic was added and stirred for a time period between about 1 minute and about 4 hours.

Acid-activated bleaching clay in an amount from about 0.5 to about 4% by weight was then added and stirred for 5 minutes. Pressure was then reduced to about 15 mbar, and the mixture was stirred for an additional 30 minutes and filtered.

The fatty acid-depleted palm oil samples were then subject to deodoration at 180-220° C. at reduced pressure of about 1-3 mbar, and injected continuously with about 1% of steam over a retention time of 30 minutes. The samples were cooled to room temperature and analyzed for monochloropropanediol (MCPDe) content, glycidyl fatty acid ester (GE) content, solid fat (SF) content and dialkylketone (DAK) content. The results, which are shown in Table 7 and Table 8 below, indicate that the fatty acid-depletion embedded alkaline treatment (FEAT) process significantly reduces 3-MCPD and diakylketone content in palm oil, without causing any alterations in solid fat content.

TABLE 7
Process contaminant presence in FEAT-treated fatty acid-
depleted palm oil (FAD PO) as compared to reference
FAD PO obtained from classic physical refining.

| | 3-MCPD | 2-MCPD | GE | DAK |
|---|---|---|---|---|
| Sample | [mg/kg] | [mg/kg] | [mg/kg] | [mg/kg] |
| Reference FAD PO | 5.2 | 1.8 | 5.5 | <2.7 |
| FEAT-Treated FAD PO | 1.0 | 1.1 | 4.0 | <2.7 |

TABLE 8
Solid fat content in FEAT-treated fatty acid-depleted
palm oil (FAD PO) as compared to reference FAD
PO obtained from classic physical refining.

| | N10 | N20 | N30 | N40 |
|---|---|---|---|---|
| Sample | [%] | [%] | [%] | [%] |
| Reference FAD PO | 46.9 | 21.3 | 7.8 | 2.8 |
| FEAT-Treated FAD PO | 44.9 | 21.6 | 8.4 | 2.8 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

### Example 6: Fatty Acid-Depleted, Embedded Alkaline-Treated Refined Palm Oil (FEAT) Physical Refining, Double Refining

Refined palm oil samples containing less than 0.1% of free fatty acids and less than 5 mg/kg phosphorus (P) were subject to fatty acid distillation at 270-290° C. at a reduced pressure of about 1 mbar and with continuous addition of 0.5-1% by weight of steam. Retention time at 285° C. was about 1 minute. The fatty acid-depleted palm oil (FAD PO) samples were cooled down to room temperature and about 50 to about 200 mg/kg caustic was added and stirred for a time period between about 1 minute and about 4 hours.

Acid-activated bleaching clay in an amount from about 0.5 to about 4% by weight was then added and stirred for 5 minutes. Pressure was then reduced to about 15 mbar, and the mixture was stirred for an additional 30 minutes and filtered.

The fatty acid-depleted palm oil samples were then subject to deodoration at 180-220° C. at reduced pressure of about 1-3 mbar, and injected continuously with about 1% of steam over a retention time of 30 minutes. The samples were cooled to room temperature and analyzed for monochloropropanediol (MCPDe) content, glycidyl ester (GE) content, solid fat (SF) content and dialkylketone (DAK) content. The results, which are shown in Table 9 and Table 10 below, indicate that fatty acid-depletion embedded alkaline treatment (FEAT) process significantly reduces 3-MCPD, GE and diakylketone content in refined palm oil, without causing any alterations in solid fat content.

TABLE 9
Process contaminant presence in FEAT-treated fatty acid-
depleted refined palm oil (RBD PO) as compared to reference
RBD PO obtained from classic physical refining.

| | 3-MCPD | 2-MCPD | GE | DAK |
|---|---|---|---|---|
| Sample | [mg/kg] | [mg/kg] | [mg/kg] | [mg/kg] |
| Reference RBD PO | 3.1 | 1.5 | 0.1 | <1.8 |
| FEAT-Treated RBD PO | 1.5 | 1.0 | 0.99 | <3.5 |

TABLE 10
Solid fat content in FEAT-treated fatty acid-depleted
refined palm oil (RBD PO) as compared to reference
RBD PO obtained from classic physical refining.

| | N10 | N20 | N30 | N40 |
|---|---|---|---|---|
| Sample | [%] | [%] | [%] | [%] |
| Reference RBD PO | 51.7 | 21.8 | 7.5 | 2.3 |
| FEAT-Treated RBD PO | 51.1 | 22.1 | 7.7 | 2.1 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

### Example 7: Pre-Treated, Fatty Acid-Depleted, Embedded Alkaline-Treated Crude Palm Oil (PFEAT)—Bench Trial, Physical Refining, Double Refining

Crude palm oil samples containing more than 1% of free fatty acids and 10 mg/kg phosphorus (P) were acid-degummed by heating to 85° C. About 200 mg/kg to about 1000 mg/kg of 50% by weight of phosphoric or citric solution and from about 0.5% to about 10% by weight of demineralized water were then added and mixed for 15 minutes, followed by acid water gum phase removal by centrifugation.

Following heavy phase separation, the samples were subject to fatty acid distillation at a temperature in a range between 270° C. and 290° C. at reduced pressure of about 1 mbar and with continuous addition of 0.5-1% by weight of steam. Retention time at 285° C. was about 1 minute.

The fatty acid-depleted palm oil (FAD PO) samples were cooled down to 220° C. and about 50 to about 200 mg/kg caustic was added and stirred for a time period between about 1 minute and about 4 hours. The mixture was then cooled down to 85° C., and about 0.5% to about 4% by weight of acid-activated bleaching clay was added to the mixture and stirred for 5 minutes. Pressure was then reduced to about 15 mbar, and the mixture was stirred for an additional 30 minutes and filtered.

The fatty acid-depleted palm oil samples were then subject to deodorization at 180-220° C. at reduced pressure of about 1-3 mbar, and injected continuously with about 1% of steam over a retention time of 30 minutes. The samples were cooled to room temperature and analyzed for monochloropropanediol (MCPDe) content, glycidyl ester (GE) content, solid fat (SF) content and dialkylketone (DAK) content. The results, which are shown in Table 11 and Table 12 below, indicate that pretreatment followed by fatty acid-depletion and embedded alkaline treatment (PFEAT) process significantly reduces 3-MCPD, GE and diakylketone content in refined palm oil, without causing significant alterations in solid fat content.

TABLE 11
Process contaminant presence in PFEAT-treated fatty acid-depleted
refined palm oil (RBD PO) as compared to reference RBD PO
obtained from classic physical refining.

| | 3-MCPD | 2-MCPD | GE | DAK |
|---|---|---|---|---|
| Sample | [mg/kg] | [mg/kg] | [mg/kg] | [mg/kg] |
| Reference RBD PO | 3.1 | 1.5 | 0.1 | <1.8 |
| PFEAT-Treated RBD PO | 1.0 | 0.6 | 0.1 | <4.6 |

TABLE 12
Solid fat content in PFEAT-treated fatty acid-depleted
refined palm oil (RBD PO) as compared to reference
RBD PO obtained from classic physical refining.

| | N10 | N20 | N30 | N40 |
|---|---|---|---|---|
| Sample | [%] | [%] | [%] | [%] |
| Reference RBD PO | 51.7 | 21.8 | 7.5 | 2.3 |
| PFEAT-Treated RBD PO | 49.1 | 21.7 | 7.9 | 2.1 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

### Example 8: Pre-Treated, Fatty Acid-Depleted, Embedded Alkaline-Treated (PFEAT)—Plant Trial, Physical Refining, Double Refining

Crude palm oil samples containing more than 1% of free fatty acids, 10 mg/kg phosphorus (P) and more than 2 mg/kg chlorine were acid-degummed by heating to 85° C. About 500 mg/kg of 50% by weight of phosphoric solution and about 2.0% by weight of demineralized water were then added and mixed for 15 minutes, followed by acid water gum phase removal by centrifugation.

Following gum phase separation, the degummed palm oil samples were subject to fatty acid distillation at 275° C. and at a reduced pressure of about 3 mbar, with continuous addition of 0.8% by weight of steam. Retention time at 275° C. was about 5 minutes.

The fatty acid-depleted palm oil samples were cooled down to 220° C. and about 200 mg/kg caustic was added and stirred for about 1.5 hours. The mixture was then cooled down to 85° C., and about 1.5% by weight of acid-activated bleaching clay was added at reduced pressure to the mixture and stirred for 5 minutes. Pressure was then reduced to about 15 mbar, and the mixture was stirred for an additional 30 minutes and filtered.

The fatty acid-depleted palm oil samples were then subject to deodorization at 230° C. at reduced pressure of about 1-3 mbar, and injected continuously with about 1% of steam over a retention time of 30 minutes. The samples were cooled to room temperature and analyzed for monochloropropanediol (MCPDe) content, glycidyl ester (GE) content, solid fat (SF) content and dialkylketone (DAK) content. As reference control, crude palm oil from the same batch was physically refined without adding caustic after fatty acid distillation. The results, which are shown in Table 13 and Table 14 below, indicate that pretreatment followed by fatty acid-depletion and embedded alkaline treatment (PFEAT) process significantly reduces 3-MCPD, GE and diakylketone content in refined palm oil, without causing significant alterations in solid fat content.

TABLE 13
Process contaminant presence in PFEAT-treated fatty acid-depleted
refined palm oil (RBD PO) as compared to reference RBD PO
obtained from classic physical refining.

| | 3-MCPD | 2-MCPD | GE | DAK |
|---|---|---|---|---|
| Sample | [mg/kg] | [mg/kg] | [mg/kg] | [mg/kg] |
| Reference RBD PO | 3.0 | 1.8 | 0.1 | <1.9 |
| PFEAT-Treated RBD PO | 1.3 | 0.8 | 0.4 | <5.2 |

TABLE 14
Solid fat content in PFEAT-treated fatty acid-depleted
refined palm oil (RBD PO) as compared to reference
RBD PO obtained from classic physical refining.

| | N10 | N20 | N30 | N40 |
|---|---|---|---|---|
| Sample | [%] | [%] | [%] | [%] |
| Reference RBD PO | 50.2 | 21.9 | 7.8 | 2.5 |
| PFEAT-Treated RBD PO | 48.7 | 23.3 | 8.5 | 2.4 |

N20 = palm oil conditioned at 20° C. and analyzed by NMR to determine solid fat content at 20° C.
N30 = palm oil conditioned at 30° C. and analyzed by NMR to determine solid fat content at 30° C.
N40 = palm oil conditioned at 40° C. and analyzed by NMR to determine solid fat content at 40° C.

It should be recognized that illustrated embodiments are only examples of the disclosed product and methods and should not be considered a limitation on the scope of the invention. Rather, the scope of the invention is defined by the following claims. We therefore claim as our invention all that comes within the scope and spirit of these claims.

1. A method for inhibiting or reducing 3-monochloropropanediol (3-MCPD), 2-monochloropropanediol (2-MCPD), glycidyl ester (GE) and dialkyl ketone (DAK) in palm oil, wherein the method comprises in non-sequential order (i) degumming or washing palm oil to produce degummed or water-washed palm oil; (ii) contacting degummed or water-washed palm oil with a base, soap or a mixture thereof and removing free fatty acids by fatty acid distillation to produce fatty acid-depleted palm oil; (iii) bleaching the fatty acid-depleted palm oil; and (iv) deodorizing bleached palm oil to obtain a degummed or water-washed, fatty acid-depleted, bleached and deodorized palm oil, thereby inhibiting or reducing 3-monochloropropanediol (3-MCPD), 2-monochloropropanediol (2-MCPD), glycidyl ester (GE) and dialkyl ketone (DAK) in palm oil.

2. The method of claim 1, wherein degumming comprises dry degumming, acid degumming, or water washing, and wherein acid degumming comprises heating the palm oil; adding acid and water to the palm oil; and removing water gum phase by gravity or density.

3. The method of claim 2, wherein the base, soap or mixture thereof is added to the degummed or palm oil prior to or after fatty acid distillation, and wherein fatty acid distillation comprises exposing the palm oil to a temperature higher than 240° C. at a reduced pressure of less than 10 mbar with continuous addition of steam.

4. The method of claim 3, wherein contacting degummed or water-washed palm oil with a base, soap or mixture thereof comprises cooling degummed, water-washed or fatty acid-depleted palm oil to a temperature higher than 180° C.; adding the base, soap or mixture thereof in an amount higher than 50 mg/kg; and stirring for a time period from 1 minute to 4 hours to obtain a caustic-palm oil mixture.

5. The method of claim 4, wherein the base, soap or mixture thereof is sodium methoxide, sodium hydroxide, potassium hydroxide, a metal oxide, a Lewis base, sodium carbonate, sodium bicarbonate, potassium carbonate, potassium bicarbonate, sodium salts of fatty acids with carbon chain length between C4 and C24, potassium salts of fatty acids with carbon chain length between C4 and C24, calcium salts of fatty acids, or any mixture thereof.

6. The method of claim 5, wherein bleaching comprises cooling the caustic-palm oil mixture to a temperature below 120° C.; adding acid-activated bleaching clay and stirring under vacuum; and filtering.

7. The method of claim 6, wherein deodorizing bleached palm oil comprises heating bleached palm oil under vacuum and continuous injection of steam.

8. The method of claim 7, wherein the degummed or water-washed, fatty acid-depleted, bleached and deodorized palm oil contains 3-MCPD and 2-MCPD in an amount of less than 2.5 mg/kg; GE in an amount of less than 1.0 mg/kg; and DAK in an amount of less than 25.0 mg/kg.

9. The method of claim 8, wherein inhibition or reduction of 3-MCPD, 2-MCPD, GE and DAK does not alter solid fat content in the degummed or water-washed, fatty acid-depleted, bleached and deodorized palm oil.

10. The method of claim 9, wherein the method comprises only one bleaching step, and wherein the bleaching step is between fatty acid distillation and deodorization.

11. The method of claim 10, wherein the palm oil is crude palm oil, a refined, bleached and deodorized palm oil, an intermediate, fractionated or modified product thereof, or mixtures thereof, and wherein the method comprises mass-producing degummed or water-washed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25.0 mg/kg.

12. A water-washed or degummed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25.0 mg/kg.

13. The water-washed or degummed, fatty acid-depleted, bleached and deodorized palm oil of claim 12, wherein the water-washed or degummed, fatty acid-depleted, bleached and deodorized palm oil is produced by a method that comprises in non-sequential order (i) degumming or washing palm oil to produce degummed or water-washed palm oil; (ii) contacting degummed or water-washed palm oil with a base, soap or mixture thereof and removing free fatty acids by fatty acid distillation to produce fatty acid-depleted palm oil; (iii) bleaching the fatty acid depleted palm oil; and (iv) deodorizing bleached palm oil to obtain a degummed or water-washed, fatty acid-depleted, bleached and deodorized palm oil.

14. The degummed or water-washed, fatty acid-depleted, bleached and deodorized palm oil of claim 13, wherein degumming comprises dry degumming, acid degumming, or water-washing, and wherein acid degumming comprises heating palm oil; adding acid and water to the palm oil; and removing water gum phase by gravity or density.

15. The degummed or water-washed, fatty acid-depleted, bleached and deodorized palm oil of claim 14, wherein the base, soap or mixture thereof is added to the degummed or water-washed palm oil prior to or after fatty acid distillation, and wherein fatty acid distillation comprises exposing the palm oil to a temperature higher than 240° C. at a reduced pressure of less than 10 mbar with continuous addition of steam.

16. The degummed or water-washed, fatty acid-depleted, bleached and deodorized palm oil of claim 15, wherein contacting degummed or water-washed palm oil with a base, soap or mixture thereof comprises cooling degummed or water-washed or fatty acid-depleted palm oil to a temperature higher than 180° C.; adding the base in an amount higher than 50 mg/kg; and stirring for a time period from 1 minute to 4 hours to obtain a caustic-palm oil mixture.

17. The degummed or water-washed, fatty acid-depleted, bleached and deodorized palm oil of claim 16, wherein the base, soap or mixture thereof is sodium methoxide, sodium hydroxide, potassium hydroxide, a metal oxide, a Lewis base, sodium carbonate, sodium bicarbonate, potassium carbonate, potassium bicarbonate, sodium salts of fatty acids with carbon chain length between C4 and C24, potassium salts of fatty acids with carbon chain length between C4 and C24, calcium salts of fatty acids, or any mixture thereof.

18. The degummed or water-washed, fatty acid-depleted, bleached and deodorized palm oil of claim 17, wherein bleaching comprises cooling the caustic-palm oil mixture to a temperature below 120° C.; adding acid-activated bleaching clay and stirring under vacuum; and filtering.

19. The degummed or water-washed, fatty acid-depleted, bleached and deodorized palm oil of claim 18, wherein deodorizing the bleached palm oil comprises heating bleached palm oil under vacuum and continuous injection of steam.

20. The degummed, fatty acid-depleted, bleached and deodorized palm oil of claim 19, wherein the palm oil is crude palm oil, a refined, bleached and deodorized palm oil, an intermediate, fractionated or modified product thereof, or mixtures thereof, and wherein the method comprises mass-producing degummed or water-washed, fatty acid-depleted, bleached and deodorized palm oil with no altered solid fat content and containing 3-MCPD and 2-MCPD in an amount of less than 2.5 mg/kg; GE in an amount of less than 1.0 mg/kg; and DAK in an amount of less than 25.0 mg/kg.
